(19) United States
(12) Patent Application Publication
(10) Pub. No.: US 2013/0221782 A1
(43) Pub. Date: Aug. 29, 2013

(54) BEARING ASSEMBLY AND MOTOR INCLUDING THE SAME

(71) Applicants: Young Sun Yoo, Suwon (KR); Yun Yeong Park, Suwon (KR); Kyung Seob Shin, Suwon (KR)

(72) Inventors: Young Sun Yoo, Suwon (KR); Yun Yeong Park, Suwon (KR); Kyung Seob Shin, Suwon (KR)

(73) Assignee: SAMSUNG ELECTRO-MECHANICS CO., LTD.

(21) Appl. No.: 13/468,728

(22) Filed: May 10, 2012

(30) Foreign Application Priority Data
Feb. 27, 2012 (KR) 10-2012-0019678

(51) Int. Cl. H02K 7/08; F16C 32/06

(52) U.S. Cl. 310/90; 384/114

(57) ABSTRACT

There are provided a bearing assembly and a motor including the same capable of securing shaft system reliability while maintaining motor slimness. The bearing assembly includes a sleeve supporting a shaft via oil; and a sleeve holder having the sleeve inserted thereinto and fixedly supporting the sleeve, wherein an upper end of the sleeve is protruded from the sleeve holder to be higher than an upper end of the sleeve holder in an upward axial direction.

### CROSS-REFERENCE TO RELATED APPLICATIONS

This application claims the priority of Korean Patent Application No. 10-2012-0019678 filed on Feb. 27, 2012, in the Korean Intellectual Property Office, the disclosure of which is incorporated herein by reference.

### BACKGROUND OF THE INVENTION

1. Field of the Invention

The present invention relates to a bearing assembly and a motor including the same, and more particularly, to a bearing assembly and a motor including the same capable of securing shaft system reliability while maintaining motor slimness.

2. Description of the Related Art

In electrical home appliances, cellular phones, and various other electrical and electronic devices requiring electric power, product miniaturization has recently been shown to be necessary for product competitiveness. Therefore, the miniaturization of several components used in electrical and electronic devices has consequently been in demand. For example, research into the miniaturization and thinning of a motor mounted in a disk drive has been undertaken.

In the motor, a bearing assembly has generally been used in order to support a shaft, a rotating member. However, in the case in which the motor is manufactured to be significantly thin, since an amount of contact between the shaft of the motor and the bearing assembly rotatably supporting the shaft, that is, a sleeve, is decreased, it may be difficult to secure stability in a shaft system of the motor.

### [Related Art Document]

(Patent Document 1) Korean Patent Laid-Open Publication No. 2011-0131792

### SUMMARY OF THE INVENTION

An aspect of the present invention provides a bearing assembly and a motor including the same capable of securing shaft system reliability while maintaining motor slimness.

According to an aspect of the present invention, there is provided a bearing assembly including: a sleeve supporting a shaft via oil; and a sleeve holder having the sleeve inserted thereinto and fixedly supporting the sleeve, wherein an upper end of the sleeve is protruded from the sleeve holder to be higher than an upper end of the sleeve holder in an upward axial direction.

The sleeve may have an outer diameter decreased toward the upper end thereof.

The sleeve may have an outer peripheral surface adjacent to the upper end thereof formed as an inclined surface.

The sleeve may have the inclined surface at a portion of the outer peripheral surface exposed outwardly of the sleeve holder.

An upper end surface of the sleeve holder may be formed as a downwardly inclined surface in an inner diameter direction.

According to another aspect of the present invention, there is provided a motor including: a bearing assembly including a sleeve supporting a shaft via oil and a sleeve holder having the sleeve inserted thereinto and fixedly supporting the sleeve; and a rotor case coupled to the shaft.

The rotor case may include a rotor hub press-fitted onto and fixed to an upper end of the shaft; a first horizontal part extended from the rotor hub in an outer diameter direction; and a second horizontal part forming a step with regard to the first horizontal part in a downward axial direction and extended in the outer diameter direction.

The rotor case may further include a step part connecting the first and second horizontal parts to each other and forming the step.

An inner peripheral surface of the step part may be disposed above the sleeve.

An inner diameter of the step part may be smaller than a maximum outer diameter of the sleeve.

An inner diameter of the step part may satisfy the following Conditional Equation in connection with a size of the inner diameter:

Sₑᵣ₁<Vᵢᵣ≦Sₑᵣ₂ (Conditional Equation)

where Vᵢᵣ indicates the inner diameter of the step part, Sₑᵣ₁ indicates an outer diameter of an upper end of the sleeve, and Sₑᵣ₂ indicates a maximum outer diameter of the sleeve.

An upper end surface of the sleeve holder may be formed as a downwardly inclined surface in an inner diameter direction.

An inner diameter of the step part may satisfy the following Conditional Equation in connection with a size of the inner diameter:

Sₑᵣ₁<Vᵢᵣ<Hₑᵣ₁ (Conditional Equation)

where Vᵢᵣ indicates the inner diameter of the step part, Sₑᵣ₁ indicates an outer diameter of an upper end of the sleeve, and Hₑᵣ₁ indicates an outer diameter of an upper end of the sleeve holder.

The rotor case may include a reception space formed by a lower surface of the first horizontal part and an inner peripheral surface of the step part, the reception space temporally storing oil leaked from the sleeve.

The reception space may have an upper end portion of the sleeve disposed therein.

The step part may connect the first and second horizontal parts in a vertical direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor according to an embodiment of the present invention;

FIG. 2 is a partially enlarged cross-sectional view of part A of FIG. 1;

FIG. 3 is an exploded perspective view showing a rotor and a base assembly of FIG. 1;

FIG. 4 is a cross-sectional view showing a motor according to another embodiment of the present invention;

FIG. 5 is a partially enlarged cross-sectional view of part A of FIG. 4; and

FIG. 6 is an exploded perspective view showing a rotor and a base assembly of FIG. 4.

### DETAILED DESCRIPTION OF THE INVENTION

Prior to a detailed description of the present invention, the terms or words, which are used in the specification and claims to be described below, should not be construed as having typical or dictionary meanings. The terms or words should be construed in conformity with the technical idea of the present invention on the basis of the principle that the inventor(s) can appropriately define terms in order to describe his or her invention in the best way. Embodiments described in the specification and structures illustrated in drawings are merely exemplary embodiments of the present invention. Thus, it is intended that the present invention covers the modifications and variations of this invention, provided they fall within the scope of their equivalents at the time of filing this application.

Exemplary embodiments of the present invention will be described in detail with reference to the accompanying drawings. The same reference numerals will be used throughout to designate the same or like elements in the accompanying drawings. Moreover, detailed descriptions related to well-known functions or configurations will be ruled out in order not to unnecessarily obscure subject matters of the present invention. In the drawings, the shapes and dimensions of some elements may be exaggerated, omitted or schematically illustrated. Also, the size of each element does not entirely reflect an actual size.

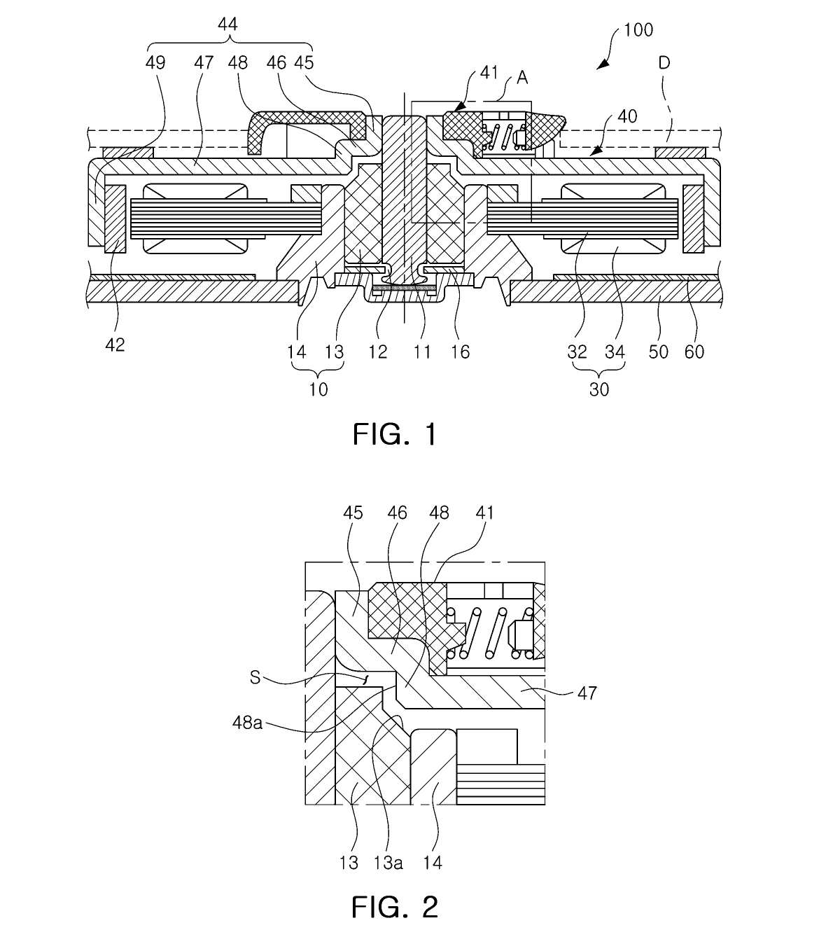

Meanwhile, terms relating to directions will be defined. As viewed in FIG. 1, an axial direction refers to a vertical direction based on a shaft 11, and an outer diameter or inner diameter direction refers to a direction toward an outer edge of a rotor 40 based on the shaft 11 or a direction toward the center of the shaft 11 based on the outer edge of the rotor 40.

Hereinafter, embodiments of the present invention will be described in detail with reference to the accompanying drawings.

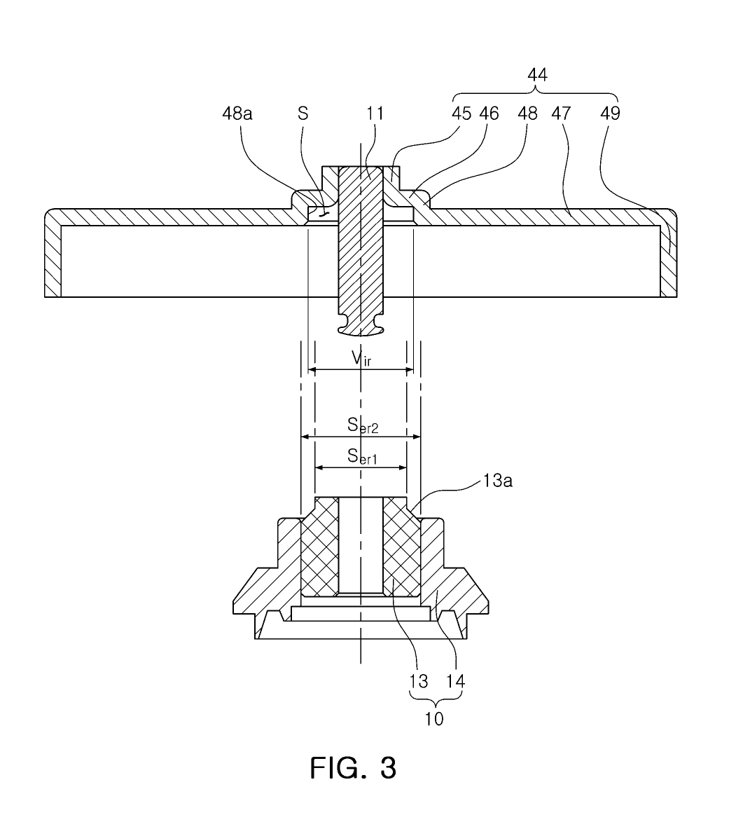

FIG. 1 is a schematic cross-sectional view showing a motor according to an embodiment of the present invention; FIG. 2 is a partially enlarged cross-sectional view of part A of FIG. 1; and FIG. 3 is an exploded perspective view showing a rotor and a base assembly of FIG. 1.

Referring to FIGS. 1 through 3, a motor 100 according to the present embodiment may be a spindle motor included in an optical disk drive rotating a disk D, and may include the shaft 11, a bearing assembly 10, a base plate 50, a circuit board 60, a stator 30, and the rotor 40.

The shaft 11 may form a rotational axis of the rotor 40 to be described below. The shaft 11 according to the present embodiment may have a stopper ring coupling groove 12 formed in a lower end thereof in order to prevent the shaft 11 from being separated from a sleeve 13 due to high speed rotation of a rotor case 44 to be described below, wherein the stopper ring coupling groove 12 has a stopper ring 16 inserted thereinto.

The bearing assembly 10 may include the sleeve 13 and a sleeve holder 14.

The sleeve 13 may have a cylindrical shape in which it has a hole formed therein, and the shaft 11 maybe inserted into the hole. The sleeve 13, a rotation support member forming an oil film between the sleeve 13 and the shaft 11 so that the shaft 11 may easily rotate and supporting the shaft 11, may serve as a bearing. An outer peripheral surface of the sleeve 13 may be press-fitted into and fixed to an inner portion of the sleeve holder 14 to be described below.

This sleeve 13 may have various pores formed by sintering and be an oil impregnation sintering bearing in which oil is impregnated into the pores.

In addition, when the sleeve 13 is disposed in the sleeve holder 14, an upper end of the sleeve 13 may be protruded from the sleeve holder to be higher than an upper end of the sleeve holder 14 in an upward direction. Therefore, the motor 100 according to the present embodiment may maximally secure stability in a shaft system since an area of contact between the sleeve 13 and the shaft 11 may be further secured by as much as protrusion of the sleeve 13.

In addition, the sleeve 13 may have a cross section smaller at an upper end thereof than at a lower end thereof. That is, the sleeve 13 according to the present embodiment may have a form in which a size of an outer diameter is decreased toward the upper end thereof.

In the case of the present embodiment, the sleeve 13 may have a form in which the outer diameter thereof is gradually decreased from a position corresponding to an upper end of the sleeve holder 14 toward an upper portion thereof. This configuration is to maximally secure coupling force between the sleeve 13 and the sleeve holder 14. However, the present invention is not limited thereto. That is, various applications may be made. For example, the sleeve 13 may have a form in which the outer diameter thereof is decreased from an inner portion of the sleeve holder 14 rather than from the upper end of the sleeve holder 14.

As the outer diameter of the sleeve 13 is decreased toward the upper end thereof, an inclined surface 13a may be formed on an outer peripheral surface of the sleeve 13 as a predetermined section. That is, a portion of the outer peripheral surface of the sleeve 13 exposed to the outside of the sleeve holder 14 may be inclined.

Meanwhile, referring to the accompanying drawings, in the case of the present embodiment, the upper end of the sleeve 13 may be formed to have a thickness equal to about half that of the lower end of the sleeve 13. However, the present invention is not limited thereto, and the upper end of the sleeve 13 may be formed to have various thicknesses as needed.

The sleeve holder 14, a fixing structure fixing the sleeve 13 inserted thereinto, may support the sleeve 13 so that the shaft 11 is rotatable via the sleeve 13. The sleeve holder 14 may include a step formed on an outer surface thereof, the step 15 being partially protruded in the outer diameter direction so that the stator 30 may be seated thereon.

The base plate 50, a support entirely supporting the other components of the motor 100, may be fixedly coupled to the sleeve holder 14 and have the circuit board 60 coupled to one surface thereof.

The circuit board 60 may be coupled to one surface of the base plate 50. The circuit board 60 may have circuit patterns (not shown) formed thereon in order to apply power to the motor 100, and be electrically connected to a wound coil 34 of the rotor 40 to be described below to apply the power to the wound coil 34. In addition, a ground pattern of the circuit patterns of the circuit board 60 may be conducted to the base plate 50. As the circuit board 60, various boards such as a general printed circuit board (PCB), a flexible PCB, and the like, may be selectively used as needed.

The stator 30 may be a fixed structure including a core 32 and the wound coil 34 wound around the core 32.

The core 32 may be formed radially toward the outer diameter direction of the shaft 11 based on the shaft 11 and be fixedly coupled to the sleeve holder 14.

The coil 34, wound around the core 32, may generate electromagnetic force at the time of applying power thereto. The wound coil 34 according to the present embodiment may be electrically connected to the circuit board 60 through a lead wire (not shown) and receive external power therethrough.

The rotor 40 may include a magnet 42 and the rotor case 44.

The magnet 42 may be an annular ring shaped permanent magnet generating magnetic force having a predetermined strength by alternately magnetizing an N pole and an S pole thereof in a circumferential direction.

The rotor case 44 may have an inverted cup shape to receive the stator 30 therein and may be press-fitted into, and fixed to, the shaft 11 to rotate together therewith.

Particularly, the rotor case 44 according to the embodiment of the present invention may have at least one step, corresponding to structures received therein, that is, the bearing assembly 10 and the stator 30. A detailed description thereof will be provided below.

The rotor case 44 according to the present embodiment may include a rotor hub 45, a first horizontal part 46, a second horizontal part 47, a magnet coupling part 49, and a step part 48.

The rotor hub 45 may be press-fitted into and fixedly coupled to the upper end of the shaft 11 and be bent in an upward axial direction in order to be firmly coupled to the shaft 11. In addition, the rotor hub 45 may have a chucking mechanism 41 coupled to an outer peripheral surface thereof, and the chucking mechanism 41 may load a disk.

The first horizontal part 46 may be extended from the rotor hub 45 along an upper end surface of the bearing assembly 10 in the outer diameter direction. Therefore, the first horizontal part 46 maybe disposed to be significantly adjacent to an upper end surface of the sleeve 13 positioned thereunder.

The second horizontal part 47 may form a step with the first horizontal part 46 in a downward axial direction and be extended along an upper surface of the stator 30 in the outer diameter direction. The second horizontal part 47 may cover the entire upper portion of the stator 30. In addition, the second horizontal part 47 may have the magnet coupling part 49 connected to an outer edge thereof.

The magnet coupling part 49 may be vertically extended from the outer edge of the second horizontal part 47 in the downward axial direction and have the magnet 42 coupled to an inner peripheral surface thereof. Here, the magnet 42 may be disposed to face the core 32 having the wound coil 34 wound therearound. Therefore, when power is applied to the wound coil 34, the rotor 40 may rotate by electromagnetic interaction between the magnet 42 and the wound coil 34. The shaft 11 and the chucking mechanism 41 coupled to the rotor case 44 may also rotate due to the rotation of the rotor 40.

The step part 48 may be extended from an outer diameter of the first horizontal part 46 in the downward axial direction, connect the first and second horizontal parts 46 and 47 to each other, and form a step between the first and second horizontal parts 46 and 47.

In addition, the upper end of the sleeve 13 may be disposed in a reception space S formed by an inner peripheral surface 48a of the step part 48 and a lower surface of the first horizontal part 46. To this end, an inner diameter (Vᵢᵣ) of the step part 48 according to the present embodiment may be larger than an outer diameter (Sₑᵣ₁) of the upper end of the sleeve 13, represented by the following Conditional Equation 1.

Vᵢᵣ>Sₑᵣ₁ (Conditional Equation 1)

where Vᵢᵣ indicates the inner diameter of the step part, and Sₑᵣ₁ indicates the outer diameter of the upper end of the sleeve 13.

As described above, the reception space S formed by the step part 48 and the first horizontal part 46 may be provided to receive the upper end of the sleeve 13. Therefore, a lower end of the step part 48 (or an inner surface of the second horizontal part) may be disposed at a position adjacent to the inclined surface 13a of the sleeve 13 while facing the inclined surface 13a.

Further, in the motor according to the present embodiment, the inner diameter Vᵢᵣ of the step part 48 may be equal to or smaller than a maximum inner diameter Sₑᵣ₂ of the sleeve 13 so that oil temporally stored in the reception space S may be again introduced to the sleeve 13. This may be represented by the following Conditional Equation 2.

Vᵢᵣ≦Sₑᵣ₂ (Conditional Equation 2)

where Vᵢᵣ indicates the inner diameter of the step part 48, and Sₑᵣ₂ indicates the maximum outer diameter of the sleeve 13.

The above Conditional Equation 2, devised in order to collect oil leaked from the sleeve 13, that is, the oil impregnation sintering bearing as described above and provide the oil to the sleeve 13 again, will be described below.

The following Conditional Equation 3 may be obtained from the above Conditional Equations 1 and 2.

Sₑᵣ₁<Vᵢᵣ≦Sₑᵣ₂ (Conditional Equation 3)

It may be appreciated from the above Conditional Equation 3 that the inner diameter Vᵢᵣ of the step part 48 according to the present embodiment has a size between that of the outer diameter Sₑᵣ₁ formed by the upper end of the sleeve 13 and that of the maximum outer diameter Sₑᵣ₂ of the sleeve 13. That is, the inner peripheral surface of the step part 48 according to the present embodiment may be disposed above the sleeve 13. This configuration is to allow for the recollection of oil leaked from the sleeve 13 to provide the oil to the sleeve 13 again, as described above.

In the case in which the shaft 11 of the motor 100 rotates at high speed, the oil impregnated in the sleeve 13 may be leaked to the upper portion of the sleeve 13 by centrifugal force, heat, and the like. The leaked oil may be diffused to an inner portion of the motor 100, the disk D, and the like, to thereby pollute the motor 110 or a device in which the motor 100 is to be mounted. In addition, repeated leakage of the oil may cause a shortage of oil in the sleeve 13, such that a lifespan of the motor 100 may be reduced.

However, in the motor 100 according to the present embodiment, the reception space S may be formed in the upper portion of the sleeve 13 by the rotor case 44, as described above. Therefore, most of the oil leaked to the upper portion of the sleeve 13 at the time of driving the motor 100 may be introduced to and temporally stored in the reception space S.

In addition, when the driving of the motor 100 stops, the oil received in the reception space S drops downwardly due to gravity. In this case, the rotor case 44 according to the present embodiment is configured such that the inner peripheral surface 48a of the step part 48 is disposed above the sleeve 13, the oil received in the reception space S may be again introduced to the sleeve 13 along the inner peripheral surface 48a of the step part 48. Therefore, the leakage of oil to the outside of the bearing assembly 10 may be significantly reduced.

The rotor case 44 according to the present embodiment may be formed by bending or pressing a single sheet of metal plate. Therefore, the rotor case 44 is not limited to being formed by the above-mentioned process, but may be formed by various methods. For example, the rotor case 44 may be formed by injection molding.

The motor according to the embodiment of the present invention configured as described above is not limited to the above-mentioned embodiments, but maybe variously modified. A motor according to an embodiment of the present invention to be described below has a structure similar to that of the motor according to the above-described embodiment of the present invention and is different therefrom only in terms of the structure of a sleeve holder and a rotor case. Therefore, a detailed description of the same components will be omitted, and the sleeve holder and the rotor case will mainly be described in more detail. In addition, the same reference numerals will be used to describe the same components as those in the above-described embodiment of the present invention.

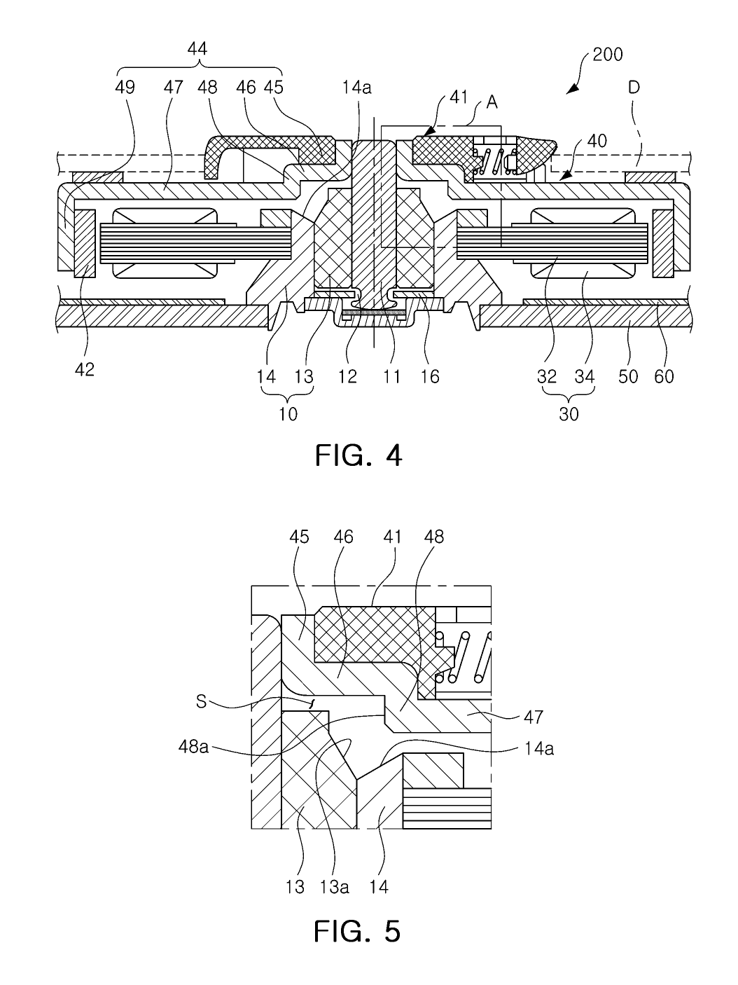

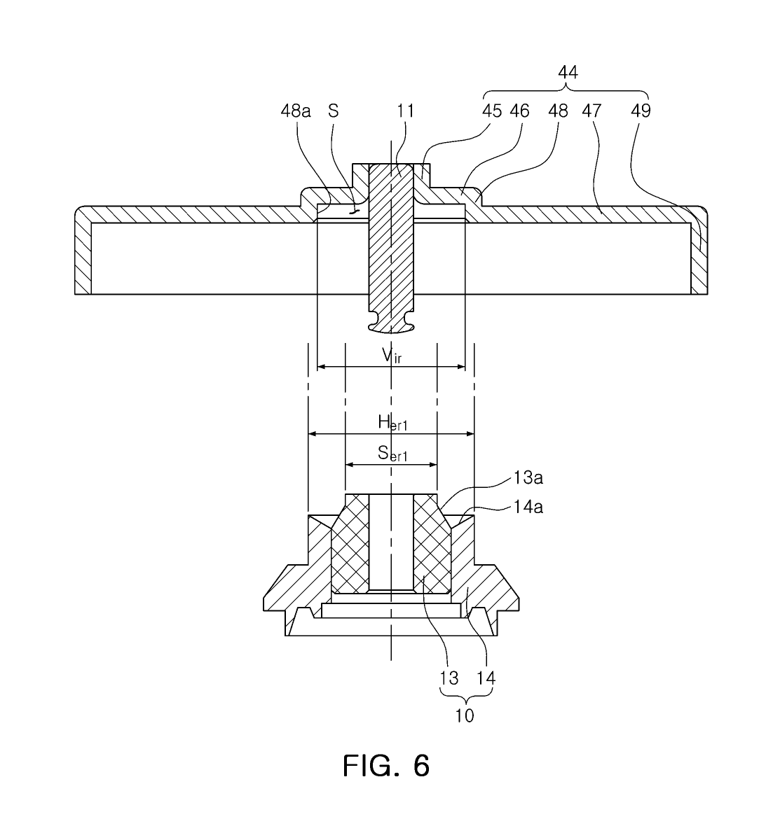

FIG. 4 is a cross-sectional view showing a motor according to another embodiment of the present invention; FIG. 5 is a partially enlarged cross-sectional view of part A of FIG. 4; and FIG. 6 is an exploded perspective view showing a rotor and a base assembly of FIG. 4.

Referring to FIGS. 4 through 6, an upper end surface 14a of the sleeve holder 14 according to the present embodiment may be formed as a downwardly inclined surface in an inner diameter direction.

Since the upper end surface 14a of the sleeve holder 14 is formed as the inclined surface as described above, in the case in which oil drops from an upper portion of the sleeve holder 14 to the upper end surface 14a of the sleeve holder 14, the oil may flow in the inner diameter direction along the inclined surface of the upper end surface 14a to thereby be introduced to the sleeve 13.

Therefore, in the motor 100 according to the present embodiment, the inner peripheral surface 48a of the step part 48 of the rotor case 44 may also be disposed above the upper end surface of the sleeve holder 14 rather than above the sleeve 13. This may be represented by the following Conditional Equation 4.

Sₑᵣ₁<Vᵢᵣ<Hₑᵣ₁ (Conditional Equation 4)

where Vᵢᵣ indicates the inner diameter of the step part, Sₑᵣ₁ indicates the outer diameter of the upper end of the sleeve, and Hₑᵣ₁ indicates the outer diameter of the upper end of the sleeve holder.

In the motor according to the embodiment of the present invention configured as described above, the reception space formed by the rotor case may be used as a space for storing the oil leaked from the sleeve, and the oil leaked from the sleeve may be temporally stored in the reception space at the time of driving the motor. In addition, the oil stored in the reception space may be reintroduced to the sleeve by gravity when the driving of the motor is stopped.

Therefore, a phenomenon in which other components are polluted or a lifespan of the motor is reduced due to the oil leaked from the sleeve may be prevented.

In addition, the motor according to the present embodiment may have a form in which the sleeve is protruded from the sleeve holder to be higher than the sleeve holder in an upward direction. Therefore, since an area of contact between the sleeve and the shaft maybe maximally secured, even in the case in which the motor is manufactured to be relatively thin, stability in a shaft system may be maximally secured.

Meanwhile, the motor and the optical disk drive using the same are not limited to the above-mentioned embodiments, but various modifications may be made by those skilled in the art without departing from the spirit and scope of the present invention.

For example, although the step part in the above-mentioned embodiment vertically connects the first and second horizontal parts to each other by way of example, the present invention is not limited thereto. That is, various modifications may be made. For example, the step part may be configured to connect the first and second horizontal parts to each other while forming an inclined surface in an oblique line direction rather than a vertical direction.

In addition, although the rotor case in the above-mentioned embodiment has only a single step part by way of example, the present invention is not limited thereto. That is, a plurality of step parts may be provided as needed. In this case, the number of horizontal parts (for example, first and second horizontal parts) maybe increased corresponding to the number of step parts.

Further, although the bearing assembly in the above-mentioned embodiment is provided in the spindle motor by way of example, the present invention is not limited thereto, but may be variously applied to a rotation device including a bearing assembly to which the shaft is rotatably coupled.

As set forth above, the motor according to the embodiment of the present invention is formed in a form in which the sleeve is protruded from the sleeve holder to be higher than the sleeve holder in an upward direction. Therefore, since an area of contact between the sleeve and the shaft maybe maximally secured, even in the case in which the motor is manufactured to be relatively thin, stability in a shaft system may be maximally secured.

In addition, in the motor according to the embodiment of the present invention, the reception space formed by the rotor case is used as a space storing the oil leaked from the sleeve, and the oil leaked from the sleeve is temporally stored in the reception space at the time of driving the motor. Further, the oil stored in the reception space may be again introduced to the sleeve by gravity when the driving of the motor is stopped.

Therefore, since the oil leaked from the sleeve is collected and provided to the sleeve again, a phenomenon in which the other components of the motor are polluted or the lifespan of the motor is reduced due to the leaked oil may be prevented.

While the present invention has been shown and described in connection with the embodiments, it will be apparent to those skilled in the art that modifications and variations can be made without departing from the spirit and scope of the invention as defined by the appended claims.

What is claimed is:

1. A bearing assembly comprising:
a sleeve supporting a shaft via oil; and
a sleeve holder having the sleeve inserted thereinto and fixedly supporting the sleeve,
wherein an upper end of the sleeve is protruded from the sleeve holder to be higher than an upper end of the sleeve holder in an upward axial direction.

2. The bearing assembly of claim 1, wherein the sleeve has an outer diameter decreased toward the upper end thereof.

3. The bearing assembly of claim 1, wherein the sleeve has an outer peripheral surface adjacent to the upper end thereof formed as an inclined surface.

4. The bearing assembly of claim 3, wherein the sleeve has the inclined surface at a portion of the outer peripheral surface exposed outwardly of the sleeve holder.

5. The bearing assembly of claim 1, wherein an upper end surface of the sleeve holder is formed as a downwardly inclined surface in an inner diameter direction.

6. A motor comprising:
a bearing assembly including a sleeve supporting a shaft via oil and a sleeve holder having the sleeve inserted thereinto and fixedly supporting the sleeve; and
a rotor case coupled to the shaft.

7. The motor of claim 6, wherein the rotor case includes:
a rotor hub press-fitted onto and fixed to an upper end of the shaft;
a first horizontal part extended from the rotor hub in an outer diameter direction; and
a second horizontal part forming a step with regard to the first horizontal part in a downward axial direction and extended in the outer diameter direction.

8. The motor of claim 7, wherein the rotor case further includes a step part connecting the first and second horizontal parts to each other and forming the step.

9. The motor of claim 8, wherein an inner peripheral surface of the step part is disposed above the sleeve.

10. The motor of claim 8, wherein an inner diameter of the step part is smaller than a maximum outer diameter of the sleeve.

11. The motor of claim 8, wherein an inner diameter of the step part satisfies the following Conditional Equation in connection with a size of the inner diameter:
Sₑᵣ₁<Vᵢᵣ≦Sₑᵣ₂ (Conditional Equation)
where Vᵢᵣ indicates the inner diameter of the step part, Sₑᵣ₁ indicates an outer diameter of an upper end of the sleeve, and Sₑᵣ₂ indicates a maximum outer diameter of the sleeve.

12. The motor of claim 8, wherein an upper end surface of the sleeve holder is formed as a downwardly inclined surface in an inner diameter direction.

13. The motor of claim 12, wherein an inner diameter of the step part satisfies the following Conditional Equation in connection with a size of the inner diameter:
Sₑᵣ₁<Vᵢᵣ<Hₑᵣ₁ (Conditional Equation)
where Vᵢᵣ indicates the inner diameter of the step part, Sₑᵣ₁ indicates an outer diameter of an upper end of the sleeve, and Hₑᵣ₁ indicates an outer diameter of an upper end of the sleeve holder.

14. The motor of claim 8, wherein the rotor case includes a reception space formed by a lower surface of the first horizontal part and an inner peripheral surface of the step part, the reception space temporally storing oil leaked from the sleeve.

15. The motor of claim 14, wherein the reception space has an upper end portion of the sleeve disposed therein.

16. The motor of claim 8, wherein the step part connects the first and second horizontal parts in a vertical direction.
